(19) United States
(12) Patent Application Publication
(10) Pub. No.: US 2021/0154771 A1
(43) Pub. Date: May 27, 2021

(54) POWDER BED FUSION RE-COATERS WITH HEAT SOURCE FOR THERMAL MANAGEMENT

(71) Applicant: DIVERGENT TECHNOLOGIES, INC., Los Angeles, CA (US)

(72) Inventors: Michael Thomas Kenworthy, Los Angeles, CA (US); Narender Shankar Lakshman, Los Angeles, CA (US); Samuel Noah Miller, Los Angeles, CA (US)

(21) Appl. No.: 16/692,918

(22) Filed: Nov. 22, 2019

(51) Int. Cl. B23K 26/342; B33Y 30/00; B33Y 40/00; B23K 26/06; B23K 26/14; B23K 26/70; B23K 26/08

(52) U.S. Cl. CPC B23K 26/342; B33Y 30/00; B33Y 40/00; B33Y 50/02; B23K 26/1464; B23K 26/702; B23K 26/0876; B23K 26/0648

(57) ABSTRACT

Techniques for pre-heating the powders of layer deposited on the powder bed during a 3-D print process conducted by a 3-D printer are disclosed. A re-coater includes a heat source that pre-heats the deposited layer as a leveling member of the re-coater smooths the layer onto the powder bed. In some embodiments, the re-coater reheats the powder bed following the selective fusing of a layer by an energy beam source. The consistent pre-heating and re-heating of the powder directly on the surface of the powder bed maximally reduces damage, cracks, dimensional flaws, and other artifacts created by excessive thermal gradients in the case where heat is not used.

### BACKGROUND

### Field

The present disclosure relates generally to additive manufacturing, and more specifically to techniques for thermal management using re-coaters in powder bed fusion-based three-dimensional printers.

### Background

Powder bed fusion (PBF)-based three-dimensional (3-D) printers generally use high-powered energy sources, such as lasers and electron beams, to selectively fuse and solidify layers of metallic powder deposited onto powder beds using re-coaters. These high energy sources can cause large thermal gradients in the powder bed during the print cycle when the fusion process occurs. These large thermal gradients, in turn, can cause stresses in the solidified material which can lead to cracks, deformations, and reduced life cycles of the printed parts. In addition, cooler temperatures of powder applied to the powder bed with respect to the fused layer can result in reduced thermal conductivity in the subsequent print cycle, which can reduce dimensional accuracy in the part and cause distortion.

### SUMMARY

Various aspects of the disclosure are set forth herein. According to one aspect of the disclosure, a re-coater for a powder bed fusion (PBF) three-dimensional (3-D) printer includes a heat source configured to heat a powder layer, the powder layer being deposited by the re-coater during a re-coat cycle.

According to another aspect of the disclosure, a powder bed fusion (PBF) three-dimensional (3-D) printer having an integrated thermal management system includes a re-coater configured to deposit a layer of powder onto a powder bed during a re-coat cycle, at least one energy beam source configured to selectively fuse the powder during a print cycle to form a build piece, and a heat source configured to heat the powder during the re-coat cycle.

According to another aspect of the disclosure, a re-coater for a powder bed fusion

(PBF) three-dimensional (3-D) printer includes a body to traverse a surface of a powder bed during a powder re-coating cycle, a leveling member coupled to the body to level a layer of powder on the powder bed, and a heat source coupled to the body to heat the powder.

Other aspects will become readily apparent to those skilled in the art from the following detailed description, wherein is shown and described only several embodiments by way of illustration. As will be realized by those skilled in the art, concepts herein are capable of other and different embodiments, and several details are capable of modification in various other respects, all without departing from the present disclosure. Accordingly, the drawings and detailed description are to be regarded as illustrative in nature and not as restrictive.

### DESCRIPTION OF THE DRAWINGS

FIG. 1 is a block diagram of a 3-D printer during a powder re-coat cycle with an embedded heat source in accordance with an embodiment.

FIG. 2 is perspective view of a re-coater coupled to a heat source in accordance with an embodiment.

FIG. 3 is a perspective view of a re-coater applying a layer of powder to a powder bed during a re-coat cycle in accordance with an embodiment.

FIG. 4 is a posterior view of the re-coater of FIG. 2.

FIG. 5 is a perspective conceptual diagram of a roller re-coater having a heat-resistive coil in a roller for use as a leveling member.

FIG. 6 is a perspective view of a conceptual diagram of a heat source integrated with a powder hopper for delivering powder to the re-coater.

FIG. 7 is a perspective view of a re-coater embedded with an array of lenses that utilize the energy beam source of the PBF printer to heat the powder bed.

FIG. 8 is a top view of a rotary PBF system having a heating source coupled to the re-coater in accordance with an embodiment.

FIG. 9 is a top view of a rotary PBF system having separate heat sources for pre-heating and re-heating the powder bed in accordance with an embodiment.

FIG. 10 is a flow diagram of a method for heating layers of a powder bed for a PBF printer in accordance with an embodiment.

### DETAILED DESCRIPTION

Powder-based-fusion (PBF) 3-D printing, a category of additive manufacturing (AM), is becoming ubiquitous in a number of industries that rely on the production of custom components. Examples include the automobile, aircraft, and transportation industries in general, among many other businesses for which AM applications have been used for producing consumer products. AM harbors this capability because manufacturers can use existing computer-aided-design (CAD) technologies to design and print structures with virtually limitless shapes and geometries. Conventionally, manufacturers have relied on expensive and project-specific tooling to produce unique parts for their product lines. This tooling often becomes obsolete when the projects have run their courses, at which time the manufacturer must often acquire expensive new tooling as a necessary prerequisite for producing new or different product designs. AM has therefore become a desirable alternative for many manufacturers to these expensive and limiting manufacturing practices.

PBF-based technologies represent a category of 3-D printers that use lasers, electron beams, or similar energy sources to produce primarily metal-based components and alloys. Examples of PBF technologies include, among many others, Direct Metal Laser Sintering (DMLS), Selective Laser Melting (SLM), Direct Metal Printing (DMP), and Direct Metal Laser Melting (DMLM). The AM process begins with a designer using a CAD program to model a 3-D representation of the part that will be printed. During a subsequent computer-aided-modeling (CAM) stage, support structures may be modeled, if needed. When a 3-D build piece is being printed, in some instances the build piece may include overhangs. The support structures are arranged under these overhangs to prevent the build piece from deforming due to gravity. In some embodiments, support structures may be incorporated into the 3-D print process, or the need for support structures may be eliminated altogether if a clever design is adopted.

After a 3-D representation of the component is modeled using a suitable CAD program, the 3-D model is “sliced” during a slice stage. In particular, a 3-D representation of the model is partitioned into a plurality of individual layers by a software application known as a slicer to thereby produce a set of instructions for 3-D printing the object. Slicer programs convert the 3-D component model into a series of individual layers representing thin slices (e.g., about 100 microns thick) of the object be printed. The sliced representation of the 3-D model is then compiled, and printer-specific instructions for 3-D printing the model are produced. These software components are uploaded as necessary to electronic storage components in the 3-D printer for access by a print controller to initiate and enable the print process. As explained below, during this process, each layer is individually deposited into a powder bed during a re-coat cycle. Thereafter, the re-coater device moves off the powder bed surface and a print cycle occurs. During the ensuing print cycle, one or more primary energy beam sources use deflectors to selectively fuse and solidify designated portions of the layer that constitute sections of the printed component, also called the build piece. After the print cycle, a re-coat cycle occurs in which the 3-D printer deposits a fresh layer of powder material into the powder bed to ready the printer for the next print cycle. Another print cycle occurs, followed by another re-coat cycle, and so on. In this way, the build piece is constructed layer-by-layer in a vertical fashion until it is complete.

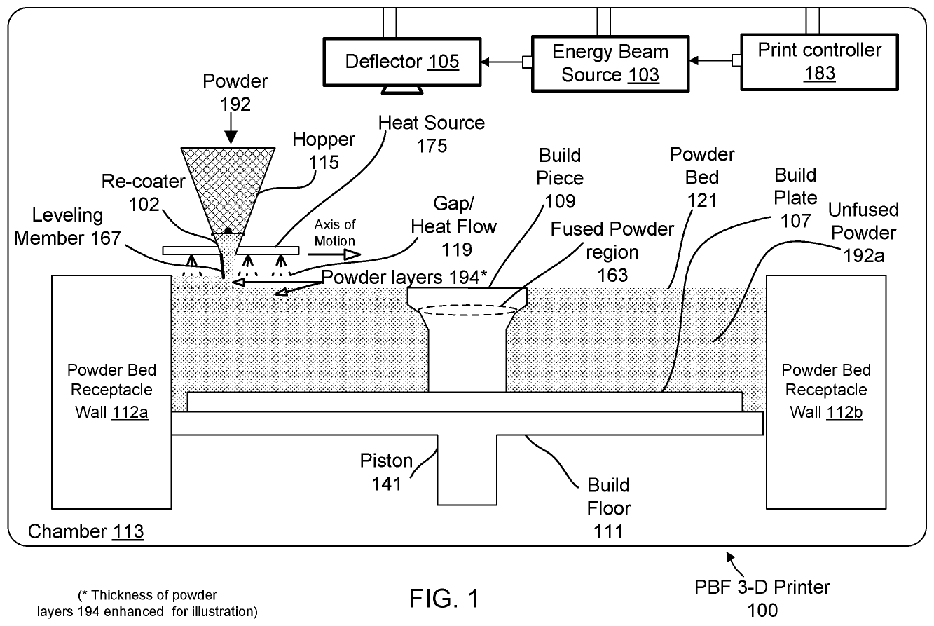

FIG. 1 is a block diagram of a PBF 3-D printer 100 with an embedded heat source 175 in accordance with an embodiment. While the PBF 3-D printer functions by implementing a combination of interleaved print and re-coat cycles, the PBF 3-D printer in FIG. 1 is shown during a re-coat cycle (also known as a powder deposition or deposition cycle). A print controller 183 receives the sliced 3-D data and print instructions, and uses this information to print the 3-D representation of the part (i.e., a build piece 109). Print controller 183 may be localized on, or integrated with, the PBF 3-D printer (e.g., in a processing system including one or more processors, memory, and optionally a user interface), or the print controller may be physically distributed across different regions of the PBF 3-D printer. In an embodiment, print controller 183 (or portions thereof) may reside on a separate workstation or PC, and thus need not necessarily be built into the printer.

A wide variety of PBF 3-D printers with different attributes and controller implementations are available, and many are customizable based on user preferences. The foregoing is intended to describe non-limiting embodiments of one such examples. The principle of operation of PBF 3-D printer 100 lies in reproducing the 3-D model by depositing and then selectively fusing, or solidifying through an energy beam source 103 (or plurality thereof), layers of a suitable powder 192 to form build piece 109 as described below. Powder 192 can be a metallic powder or an alloy, and serves as the print material for PBF 3-D printer 100.

During a current re-coat cycle as illustrated, a re-coater 102 traverses a horizontal axis of motion to deposit a powder layer 194 over a previously-deposited powder layer. During preceding re-coat cycles, the powder layers were deposited by re-coater 102 one over the other, beginning originally with a first powder layer deposited on a substrate such as a build plate 107. In FIG. 1, top-most powder layer 194 has been partially deposited in a powder bed 121 as the re-coater 102 travels along the axis of motion over a surface of the powder bed. It will be appreciated that the thickness of powder layer 194 relative to the powder bed has been enhanced to more effectively illustrate the deposition process. In fact, the powder layers are typically small and range from about 20-120 microns.

Following a re-coat cycle in which the powder layer is deposited, a print cycle may occur to solidify portions of that powder layer. Energy beam source 103 can be collimated to produce the precise energy beam needed to selectively melt and then solidify selected cross-sectional regions of the deposited powder layers during the ensuing print cycle. In particular, energy beam source 103 melts selected regions of the powder layer by emitting an energy beam (e.g., a laser, electron beam, etc.) at a deflector 105. The deflector can dynamically be oriented at various predetermined angles as controlled by instructions from print controller 183. The resulting energy beam emitted by energy beam source 103 and reflected from deflector 105 strikes and thereby melts the selected regions of the powder layer. After the temperature cools, the melted portions cool and solidify. The remaining unfused powder 192a can be removed later for recycling.

During this time, re-coater 102 has moved away from the print area to avoid interfering with the print cycle. For example, re-coater 102 may position itself at the far right just above a right powder bed receptacle wall 112b, if during its immediately prior re-coat cycle the re-coater moved from left to right. Likewise, if the last re-coat cycle caused the re-coater to end on the left side, the re-coater can position itself at the far left above a left powder bed receptacle wall 112a.

Referring back to the print cycle, in FIG. 1, selected portions of the powder layer (corresponding to fused powder region 163) are fused by energy beam source 103. The melted powder in the powder layer thereafter solidifies to form fused powder region 163. Each powder layer 194 typically includes a corresponding one of the fused powder regions, each of which forms a cross-section of build piece 109. Between each successive re-coat cycle, another print cycle occurs such that energy beam source 103 acts on each powder layer 194 as described above to create the fused powder region associated within the powder layer most recently deposited. Following each print cycle, another re-coat cycle may occur. This alternating process may continue until build piece 109 is completed. In an embodiment, a plurality of energy beam sources and corresponding deflectors are distributed across an upper surface of the PBF 3-D printer to perform 3-D print operations in parallel.

PBF 3-D printer 100 may include a chamber 113 in which the basic print elements are arranged. The chamber may be pre-filled with an inert gas, such as argon. The chamber advantageously isolates the print elements from unwanted particles or other elements in the air. Further, because argon is inert, the print material in chamber 113 is not likely to perform unwanted chemical reactions. For example, absent the isolating chamber, powder 192 would likely engage in unwanted oxidation reactions due to the oxygen in the air. Other undesirable chemical reactions result. Sealing the print elements and housing them in chamber 113 with an appropriate inert substance, as shown in FIG. 1, largely eliminates these problems. In other embodiments, a chamber may not be required.

Build plate 107 is arranged at a horizontal base of 3-D printer 100 adjacent a build floor 111. The build plate is also adjacent powder bed receptacle walls 112a-b on each side to collectively form powder bed 121. Build floor 111 may include a piston 141 configured to successively move build plate 107 downward in a vertical manner after each print cycle. Piston 141 may move build floor 111 vertically downward for a distance after each print cycle that coincides with a thickness of powder layer 194. In this manner, piston 141 can keep the surface of powder bed 121 and build piece 109 at a fixed distance from energy beam source 103, enabling piston 141 to help ensure print uniformity. In short, piston 141 operates to periodically move build floor 111 downward to prevent the powder layers from accumulating at the top of powder bed 121, which in turn provides a substantially fixed distance for enabling PBF 3-D printer 100 to complete build piece 109 of any size that otherwise fits within chamber 113, governed by the printer's specifications.

In an embodiment, PBF 3-D printer 100 includes a hopper 115, which is a storage structure primarily used to store powder 192 that will be used during the re-coat cycles. In other embodiments, the powder storage mechanism may be in a reservoir adjacent one of powder bed receptacle walls 112a-b, in some cases using a mechanism similar to piston 141 to push the powder in the reservoir upward for easier acquisition as more layers 194 are formed and more powder 192 is needed. In the embodiment shown, hopper 115 is connected to re-coater 102. The re-coater 102 can receive powder 192 from hopper 115 (or, in other embodiments, from a separate source) before traversing the surface of powder bed 121 to successively deposit the thin and uniform layers of powder 192 as described above. Hopper 115 may, but need not, be permanently connected to re-coater 102. In an embodiment, hopper 115 may use one or more apertures or channels, or tubes (collectively represented by the small black member in between hopper 115 and re-coater 102) to fill an open cavity present in the re-coater 102 with powder 192 as needed, so that the re-coater 102 can refill its stock of powder 192 when running low. In this embodiment, re-coater 102 can periodically reconnect with hopper 115 above left powder bed receptacle wall 112a to receive refills as needed. In other embodiments, hopper 115 is permanently attached to re-coater 102 and moves along with re-coater 102 during a re-coat cycle.

Referring still to FIG. 1, it is important for accuracy of the build job to ensure that the layers being deposited are as smooth as possible. As such, in one embodiment, a leveling member 167 is coupled to the re-coater 102. The leveling member 167 may be a component of the re-coater. Leveling member 167 may be a blade. The blade may be a hard blade, a soft blade, or somewhere in between. The blade may be metallic, plastic, or hard rubber, and may have different shapes that optimally facilitate its intended purpose. In other embodiments, leveling member may be a rolling member (see below). A primary function of the leveling member is to smoothly and evenly distribute powder 192 deposited from re-coater 102 onto powder bed 121 during the re-coat cycles. Leveling member 167 levels and thus smoothens powder 192 as it is applied by re-coater 102 to ensure a uniform powder application free of bumps, gaps, or other artifacts in the layer. As re-coater 102 traverses the surface of powder bed 121 during a re-coat cycle in the direction of the illustrated axis of motion, the re-coater dispenses powder 192 while leveling member 167 (which may again be an element of the re-coater) simultaneously smoothens the powder in a uniform manner as described. After the re-coat cycle, when the layer is deposited onto powder bed 121 and the re-coater has moved across the powder bed, the re-coater 102 can move off powder bed 121 (e.g., over right powder receptacle wall 112b) to allow the next print cycle to begin.

Alternatively, the re-coater 102 can be bi-directional. In this case, re-coater 102 can move in both left and right directions in the printer shown and may, for example, return from right powder receptacle wall 112b after the print cycle, during which time the re-coater and leveler deposit another layer. After this re-coat cycle, re-coater may then move to left powder bed receptacle wall 112a and out of the way before the next print cycle begins.

In an aspect of the disclosure, heat source 175 is coupled to re-coater 102. Heat source 175 will be described further below.

As described above with reference to FIG. 1, during each print cycle, print controller 183 provides instructions to the various circuits including energy beam source 103 that is used in conjunction with deflector 105 to print the latest layer deposited during the most recent re-coat cycle. Although a plurality of energy beam sources may be used in a single PBF 3-D printer, one is illustrated for ease of explanation. In operation, energy beam source 103 emits an energy beam of laser, electrons, or another known energy beam. The energy beam strikes the deflector 105, such as a mirror or a reflective metal. Deflector 105 is configured to align itself in different orientations per print controller 183 instructions. Deflector 105 focuses the beam onto a specific part of powder bed 121 where the layer in question is exposed. The deflector 105 sends the collimated beam of energy to strike selected portions of the layer that it will solidify. As it emits the energy beam to solidify various portions of the layer, the deflector 105, by virtue of its high temperatures, may cause a molten weld pool to be temporarily produced in the vicinity of the energy beam, as briefly noted above.

As the temperatures reduce and the energy beam moves on to fuse other portions of the layer, the weld pool quickly reduces in temperature and causes the local portion of the layer to solidify into the general shape intended by the energy beam source. The energy beam source 103 activity continues during this print cycle until the remaining selected portions of the layer has been fused. The powder 192 not fused during the layer falls into powder bed 121 as shown. The print cycle is complete, and the re-coater 102 readies itself for deposition of the next successive layer. This downward shift ensures that the powder bed remains between powder bed receptacle walls 112a-b and that re-coater 102 and energy beam source 103 remain at the same relative distance from a surface of powder bed 121 during the printing of each layer. at the end of the build job, the build piece 109 can be extracted and PBF 3-D printer 100 can be readied for the next component as determined by the next 3-D model.

The above description of a PBF printer is exemplary in nature. As described above, a number of specific PBF designs and products are available, and these known designs and products are intended to fall within the scope of the present disclosure. Other PBF systems are similar in functionality in terms of the techniques relevant to this disclosure, and therefore the concepts herein apply with equal force to other such PBF printers.

A deficiency noted above with all such PBF printers is that the thermal gradients introduced to the different layers can be large. These gradients can crack the build piece, or cause deformation over time. More precisely, during the print cycle, the metallic powder material that is deposited at room temperature to form a given layer can be suddenly exposed to very high temperatures when struck by the energy beam from deflector 105 and energy beam source 103. In some cases, the selectively fused powder goes from room temperature to a very high temperature in a very small amount of time. Thereafter, the fused powder in the layer is left to solidify as the temperature again drops quickly from a very high value back toward room temperature. In addition, immediately after the print cycle, there may be a number of warm or hot areas of the layer adjacent the remainder of the layer, the latter of which may be comparatively cooler.

In addition to the thermal gradients directly experienced by the fused regions in each layer, local thermal gradients are also present between the hot fused powder regions (e.g., fused powder region 163) and the non-printed regions of unfused powder 192a. This latter class of local thermal gradients can also abruptly introduce high temperatures and can result in additional thermal stresses to the material as a result. That is to say, the hot, fused regions cool faster than the adjacent unfused regions. These temperature differentials can often cause structural problems.

More precisely, the thermal gradients introduced during the print cycle are often higher than the powder material can reasonably withstand. The fast temperature changes can result in thermal stresses (whether or not visible), cracks, dimensional inaccuracies, structural deformations and other problems that occur during the process or after a shortened lifetime when the manufacturers have extracted the build piece 109 and have inserted it, for example, as a component in a vehicle or other mechanical structure.

Practitioners in the art have recognized the problems associated with significant temperature transients in the powder, but unfortunately few if any viable solutions have been proposed. The attempts to reduce this problem to date have included generally heating the entire chamber of the PBF 3-D printer 100, or attempting to heat the entire powder bed by heating the build plate 107. Heating temperatures in these cases may be from 200 to 400° or greater. These prior approaches generally rely on non-local, continuous heating mechanisms that consume a large amount of energy and that are not directed at the problem areas, i.e. the thermal gradients produced at the top layer of each system. More specifically, globally heating the entire print chamber fails to target the problem areas, as does heating the build plate, which, as the build job progresses, may eventually be dozens or hundreds of layers away from the site of the thermal gradients. These conventional approaches instead place potentially unnecessary heating stresses on unaffected portions of the PBF 3-D printer 100. Moreover, such global heating represents a grossly inefficient and expensive solution in terms of the energy expenditure.

In contrast to these prior approaches, direct heating of the powder as described in this disclosure helps to maintain a constant powder bed temperature, in contrast to simply increasing the temperature of the chamber or the build plate as in conventional proposals. In particular, in one aspect of the disclosure, heat source 175 (FIG. 1) is coupled to or otherwise embedded or integrated in re-coater 102 for pre-heating and/or post-heating (re-heating) powder 192 locally, at the layers where the build job is taking place in real time and where the thermal problems are present. As can be seen in the example of FIG. 1, re-coater 102 is coupled to heat source 175, which in one embodiment can include a one-sided array of standard heating elements (e.g., embedded diode laser arrays, LED lamps, photo-diodes, heat lamps, infra-red lamps, resistors, etc.) that print controller 183 or another mechanism can selectively activate during the re-coat cycles. Heat source 175 can adopt a variety of geometries and can be integrated with the re-coater in different ways without departing from the scope of the disclosure. In the embodiment shown, heat source 175 is a generally rectangular structure that is arranged to extend across powder bed 121 as re-coater 102 moves. In an embodiment, re-coater 102 can use a raster scan energizing of the heating elements to pre and/or post heat powder bed 121. The use of a raster scan to obtain a desired temperature or thermal swing can save energy.

Unlike in prior approaches, one advantageous aspect of the present disclosure is that re-coater 102 is capable of both pre-heating and reheating the affected areas as described. This technique can more efficiently improve the printing of particularly crack-sensitive metals and alloys, given that crack sensitivity can be highly dependent on the thermal stress characteristics of the build piece 109.

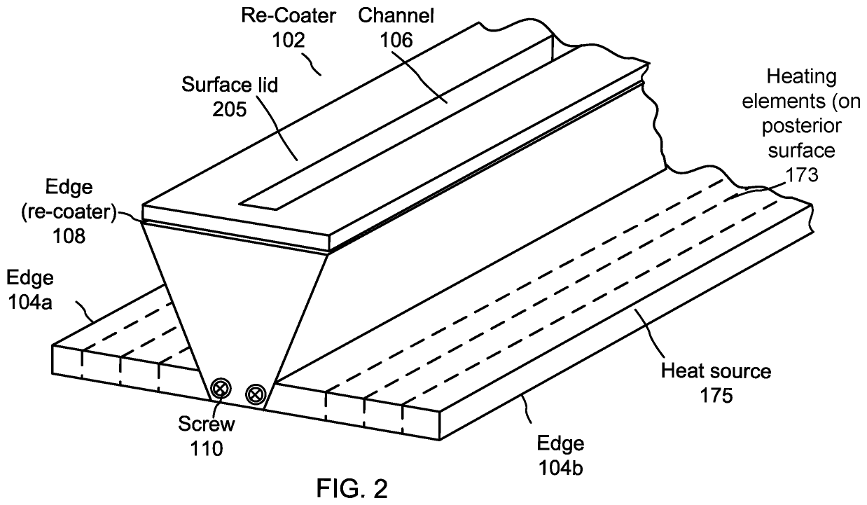

In the center of re-coater 102, powder 192 is received via a channel from hopper 115 as described above. Hopper 115 is illustrated with a different texture than re-coater 102 to enable a viewer to more easily distinguish these structures. Re-coater 102 may have additional channels at a posterior surface adjacent the leveling member (see FIG. 2).

As powder 192 exits the re-coater during the re-coat cycle and the re-coater 102 traverses the powder bed 121 at a fixed height above the surface of the powder, heat source 175 emits a heat flow 119 in the gap defined by the distance between a posterior surface of the heat source 175 and the surface of powder bed 121 where the next layer is being deposited. Adjacent leveling member 167 where powder 192 is smoothened after exiting re-coater 102, heat source 175 emits heat flow 119 to pre-heat the powder to a predesignated temperature, which may be set by print controller 183. The lines of heat, representing radiation in the form of photons or the like, can be emitted from the heating elements on heat source 175. In the embodiment shown, heat source 175 is configured to heat both the surface layers in front of and behind leveling member 167 as re-coater 102 moves to the right. Once the re-coater 102 reaches the far side of powder bed, the re-coater 102 may move out of the path of the powder layer and above right powder bed receptacle wall 112b in order to allow the print cycle to commence on the recently deposited layer.

As the print cycle is conducted, the areas on the layer corresponding to the software 3-D model are fused under the command of print controller 183. Because the powder is, immediately prior to the print cycle, warmer than it would have been due to the application of heat source 175 during the re-coat cycle, the heating caused by energy beam source 103 during the print cycle results in a less dramatic thermal gradient. That is, when the fused powder begins to cool and solidify, it already was heated, and therefore the heating transient over a short time t is reduced. Thermal stresses are therefore immediately and locally reduced without the necessity of pre-heating the entire chamber or the entire print bed.

In an embodiment, a reheating procedure immediately follows the print cycle. The purpose of the reheating procedure is to further reduce thermal transients, and therefore reduce thermal stresses that can otherwise cause part failures down the line. Re-coater 102 may be bi-directional and may return from the right side back to the left side of PBF 3-D printer 100. During the trip from right to left, heat source 175 again emits thermal radiation over the cooling powder bed (e.g., using a raster scan) to further ensure that thermal gradients are minimized. After the print cycle, re-coater 102 may engage in the next re-coat cycle, whereby it travels over the powder bed from left to right to deposit a next layer and pre-heat the layer. The print cycle repeats in the manner described above, and so on until the build is complete.

In an alternative embodiment, re-coater 102 is further bi-directional in that it includes posterior apertures (see FIG. 2) that enable re-coater 102 to deposit a layer and effect a re-coat cycle while traversing powder bed 121 either from left-to-right or from right-to-left, as the situation mandates. For example, re-coater 102 can move left-to-right to apply its re-coat and heat cycle, and then the re-coater can pause on the right while the subsequent print cycle occurs. The subsequent print cycle can be immediately be followed by a right-to-left re-coat cycle. In this case, re-coater 102 can apply heat locally as it traverses the powder bed performing re-coat cycles in both directions.

FIG. 2 is perspective view of a re-coater 102 coupled to a heat source in accordance with an embodiment. For simplicity, the leveling member 167 is not specifically illustrated in this example, although it will subsequently be illustrated and discussed further. It will be appreciated that only a portion of the re-coater 102 is shown, as the other portion directed into the paper is symmetrical with the illustrated device. In this embodiment, the re-coater 102 is shaped like a mini-hopper and includes a channel 106 through which powder can flow from hopper 115 as needed. Inside the re-coater 102 is a cavity (obscured from view) which holds the powder 192. On top of re-coater 102 is a surface lid 205 which protects the hopper from contaminants and in this embodiment, prevents an excess amount of powder 192 from entering the re-coater 102 via hopper 115. Surface lid 205 is sealed around re-coater 102 at edge 108, which can secure the surface lid by means of an adhesive or other mechanical fastening element.

At the bottom of the re-coater 102, a generally rectangular heat source 175 is coupled to the lower or posterior surface of re-coater 102. Mechanical elements such as screws 110 may be used to connect the heat source 175 to the re-coater 102. The heat source 175 in this embodiment is shaped such that, unlike conventional approaches, it can bi-directionally apply heat locally to the deposited powder as it traverses the powder bed above the pre-determined gap. In particular, heat source 175 includes edge 104a on one side of re-coater 102, and edge 104b on the other side of re-coater 102. Thus, in this embodiment, heat source 175 is symmetrically positioned on both sides of re-coater and is optimized for heating the powder bed in either direction based on bi-directional movement of re-coater 102. While the leveling member 167 deposits and levels the layers during the re-coat cycles (FIG. 1), the heat source 175 can apply heat to the surface of powder bed 121 between the gap (FIG. 1) on both sides of the re-coater.

In the example shown, the dashed elements represent an arrangement of heating elements 173, such as light emitting diodes, that are positioned on a posterior surface of heat source 175. To increase the maximum heat exposure to the surface of powder bed 121, the heating elements extend from the posterior surface at edge 104a across the posterior surface to edge 104b, interrupted only by the portion of re-coater 102 used for depositing powder (e.g., blade 338 and the aperture described below). As is evident from the illustration, the rectangular shape of heat source 175 is configured to cover the edges on each side of powder bed 121 such that heat can be applied to the entire powder bed as the re-coater 102 moves from side to side during re-coat cycles. In other embodiments, heating elements 173 are confined to the posterior surface of heat source 175 (obscured from view), where they are distributed across the posterior surface from edge 104a to edge 104b on both sides of re-coater 102.

In an embodiment, heat source 175 includes electronic solid-state circuitry to control the temperature and activation/deactivation of heating elements 173, and also to interface with print controller 183 as needed. These electronics may alternatively be included in re-coater 102. The re-coater may have an internal plug that leads to a power source in PBF 3-D printer 100 for controlling the heating elements.

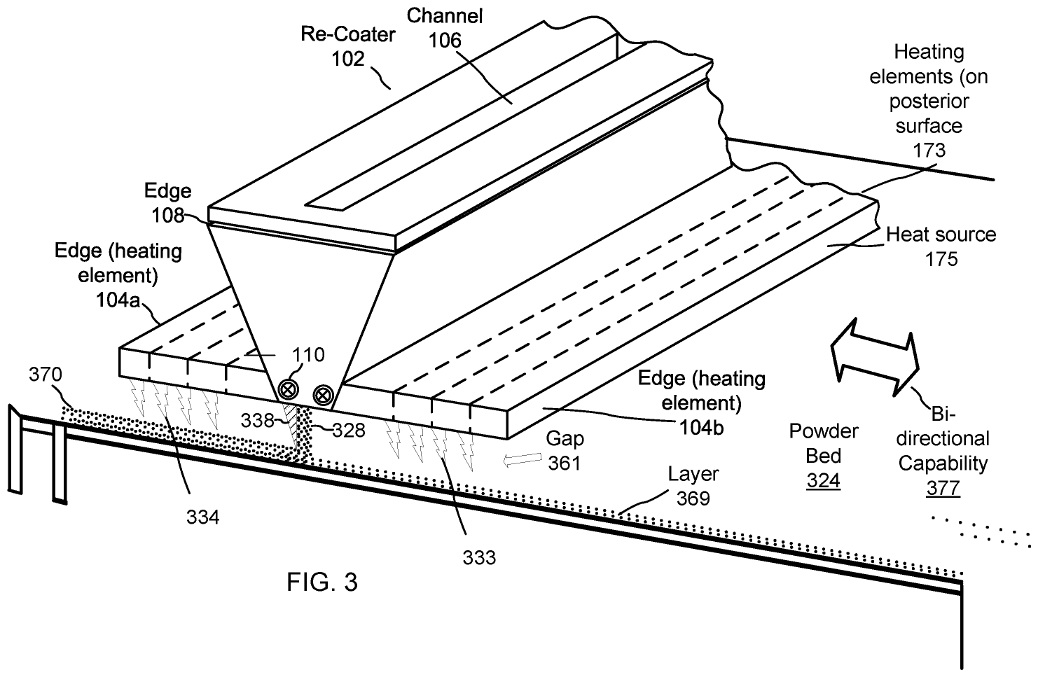

FIG. 3 is a perspective view of a re-coater 102 applying a layer of powder to a powder bed 324 during a re-coat cycle in accordance with an embodiment. FIG. 3 is a simplified representation in that the recently deposited layers 370 are represented only at the sides by the series of dots, but in reality they extend across the plane of the powder bed 324 to the other side of re-coater 102 (i.e., into the drawing) and to the left of blade 338. In addition, only one side of the re-coater 102 is shown for clarity, but the action of the other side is ordinarily symmetric to the side that is shown. For example, in some embodiments, re-coater 102 may include another blade opposing blade 338 and otherwise symmetrical to blade 338 that can be used to level powder in a re-coat cycle in the left direction utilizing a bi-directional capability 377. Alternatively, a single blade may be symmetrically shaped to level powder in both directions. In this latter embodiment, re-coater may be configured to supply powder to the powder bed on the opposite side of blade 338 when re-coater 102 is moving left. Other portions of re-coater 102 have been simplified in FIG. 3 to avoid unduly obscuring the concepts of the invention. For example, layer 369 is only shown at the edge of powder bed 324, but like layers 370, in fact it extends across the powder bed 324 in all unfused regions.

FIG. 3 represents re-coater 102 during a re-coat cycle as it begins to move from left-to-right across the surface of the powder bed 324, separated by gap 361. Bi-directional capability 377 of the re-coater 102 allows the re-coater to perform re-coat cycles in both directions as it moves from left-to-right on one hand, and right-to-left on the other hand. The embodiment can include a pre-heating and/or reheating cycle. FIG. 3 shows re-coater 102 during a re-coat cycle. A controlled flow of powder 328 is flowing from an aperture in the re-coater adjacent the leveling member 338, which in this embodiment is a soft plastic blade with some flexibility to bend as the powder 328 is deposited as a uniform layer on the powder bed. The blade 338 smoothens and levels the powder across the front and rear directions of the printer, effectively depositing the powder 338 as close to a uniform plane of material as possible. In another embodiment, to the left of blade 338 is another aperture, closed during this application, that is used to apply a layer of powder during a re-coat cycle from right-to-left in printers that allow this capability. Here, layer 369 is being pre-heated by the array of heating elements (obscured from view) on the right rear side of blade 338, as shown by the symbols of photons 333.

As blade 338 deposits and levels powder 328, a series of heating elements such as LED lights emit photons across the plane of the lower member of the heat source 175 in gap 361 to heat the deposited powder to a temperature designated by the print controller. As the re-coater 102 moves from left to right, a first set of heating elements (conceptually shown by photons 333) heats the powder bed 324 that has yet to receive the new layer. After the topmost layer of layers 370 is deposited, heat source 175 has additional heating elements (conceptually shown by photons 334) that apply a designated amount of heat to the deposited layer. The re-coater traverses powder bed 324 until it reaches the other side. Thereupon, in one embodiment, the print cycle begins as re-coater 102 remains out of the way of powder bed 324. In another embodiment following arrival at the right of the printer, re-coater 102 can return left back to a position out of the way of the powder bed while applying additional heat (333 and 334) but without disturbing the new layer 334. In this alternative embodiment, the print cycle begins right after the re-coater 102 arrives on the left side of the 3-D printer.

In either case, the print cycle can begin after the re-coat cycle. Heat source 175 selectively fuses the layer based on the data model provided by the CAD program and the corresponding print instructions. Thereafter, re-coater 102 can reheat the powder bed as the new components are solidified by traversing the powder bed again and applying heat 333/334 via gap 361.

Briefly referring back to FIG. 1, one advantage of the implementation is that the re-coater 102 can allow for the usage of lesser power from energy beam source(s) 103 during the print cycle. This is because re-coater 102 has already pre-heated powder bed 121 to a higher temperature, and thus less power from energy beam source 103 is needed to fuse build piece 109. In this way, power can be conserved. Furthermore, as noted above, direct heating of the powder helps to maintain a constant powder bed temperature, in contrast to simply controlling the temperature of the build plate indirectly from the bottom of powder bed 121 as in conventional proposals.

The array of heating elements of the embedded heat source of re-coater 102 helps assure reduction of thermal stresses to benefit crack-sensitive materials and to improve overall component quality while concurrently maximizing efficiency of power use by, among other attributes, applying direct heating to the layers separated by a small gap.

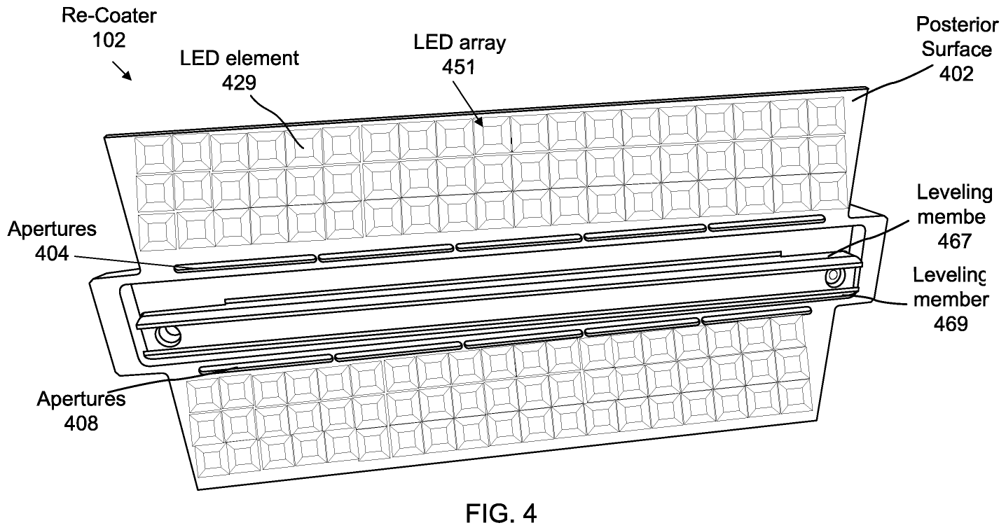

FIG. 4 is a view of a posterior surface 402 of re-coater 102 of FIG. 2. Re-coater 102 includes posterior surface 402 that is coated with an array of heating elements (omitted for clarity) as described above. In this embodiment, re-coater 102 includes two leveling members 467 and 469. These leveling members 467 and 469 may constitute hard metallic blades, softer plastic blades, flexible blades made out of rubber, or other structures. The purpose of the dual-blade system is to enable the re-coater to accurately apply a layer in either direction—that is, re-coater 102 can be used for re-coat cycles in both left-to-right and right-to-left directions using the correct leveling member designed to deposit the layer in the correct direction. This configuration can minimize the movement of re-coater 102 since the bi-directional capability to add layers means that after one pass over the powder bed, the re-coater need not return to the other side. This also ensures that the heating process is maintained consistently without significant interruptions. Once the blade passes over the powder bed, for example, the next print cycle can begin immediately. After this print cycle, the re-coater 102 can pass over the freshly fused layer and reheat the powder bed without adding another layer. In alternative embodiments, blade 469 can immediately be put into action to add another layer, if desired.

A series of first apertures 404 are disposed linearly across posterior surface 402 of re-coater 102 on one side to deposit powder for one of the leveling members 467 (e.g., a blade) as the re-coater 102 applies a layer in a first direction. Conversely, a series of second apertures 408 are disposed across posterior surface 402 of the re-coater on the other side to provide powder to a second leveling member 469 (e.g., a blade) as the re-coater 102 optionally applies a layer in a second direction. In an embodiment, the surface area of posterior surface 402 is as large as possible to apply a larger number of light emitting diode (LED) heating elements 429 to form LED array 452, and to ensure the leveling members 467, 469 are long enough to extend across a width of the powder bed. In other embodiments, a single blade or leveling member can be used, such as when using a uni-directional re-coater, or when the leveling member is bi-directional.

Other PBF systems use rollers to apply powder layers and to smooth the powder layers onto the powder bed. In an embodiment, the roller is coupled to or part of a re-coater for use in applying the powder. In other embodiments, the roller constitutes the re-coater itself. The roller may obtain the powder from an existing or adjacent reservoir of powder, or from a hopper. The present disclosure is intended to cover each of these embodiments.

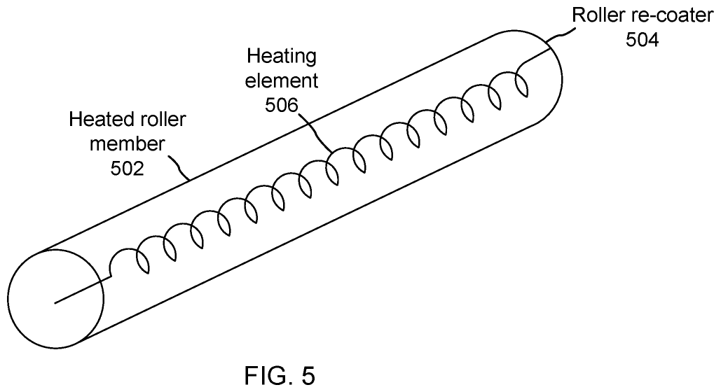

FIG. 5 is a perspective conceptual diagram of a roller re-coater 504 having a heating element 506 in a heated roller member 502 for use as a leveling member. Roller re-coater 504 has at one end a voltage or energy source (not shown) as well as a mechanical member attached to a frame of the printer for moving heated roller member 502 across a surface of the powder bed. In an embodiment, the heating element 506 comprises a coil that heats heated roller member 502, and therefore heats the powder that heated roller member 502 is smoothening. In this manner, the roller re-coater 502 can pre-heat and/or reheat the powder bed.

The leveling member 502 of FIG. 5 is useful for the comparatively large number of PBF printers that use a roller as the leveling member and/or re-coater. Advantages of heated roller member 502 include savings in power (as opposed to heating the entire print bed, e.g., via the build plate), reduction of power required by the primary energy beam sources (e.g., energy beam source 103) during print cycles (in that as noted above, hotter powder requires lower thermal stimuli to reach the fusion threshold), compactness, and the ability to apply heat directly onto the powder bed. Additionally, heat is not provided where heat is not needed.

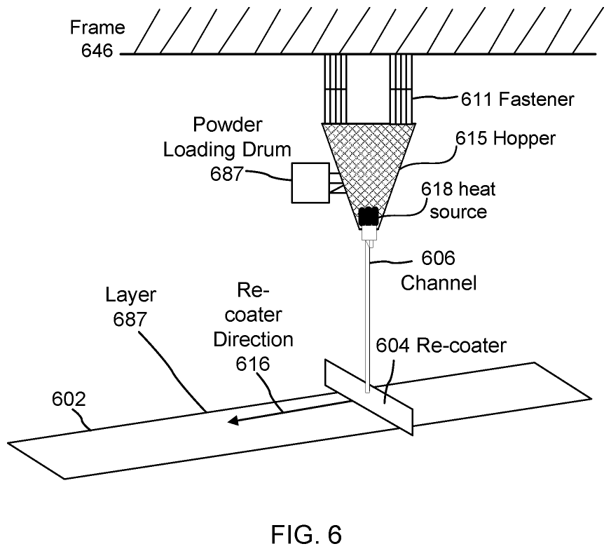

In other embodiments, the heating element may be integrated with the hopper to effect fast and efficient pre-heating and reheating]. FIG. 6 is a perspective view of a conceptual diagram of a heat source 618 integrated with a hopper 615 for heating the powder stored in the hopper before the hopper delivers powder via a channel 606 to re-coater 604. The main difference in this embodiment is that, instead of being heated at the re-coater, the powder is heated before, or concurrently as, it exits the hopper. As the heated powder is in transit via channel 606 to re-coater 604 for application of a layer 687 onto a powder bed 602 while re-coater 604 is moving in re-coater direction 616, the layer is being deposited as heated to a designated temperature. In other embodiments, the heat source may reside outside hopper 615 for heating the powder exiting the hopper and en route via channel 606 to re-coater 604. In some embodiments, channel 606 may be operably releasable from hopper 615 (e.g. under dynamic instructions from print controller 183) so that re-coater 604 can be connected to another hopper. The configuration may be such that re-coater 604 is given autonomy from hopper 615 during the re-coat cycle so that the re-coater is not restrained by unwanted hardware connections while the re-coater moves along powder bed 602.

With continued reference to FIG. 6, powder bed 602 includes re-coater 604 as described above, drawn conceptually, which can run across powder bed 602 in re-coater direction 616 to apply a layer. While re-coater 604 is moving left to right as shown by the 616, in other embodiments the opposite may be the case, and if the re-coater has bi-directional capability, the re-coater may in other cases be moving right to left. Hopper 615 may be coupled to or supported by a frame 646. In alternative embodiments, hopper 615 may be configured as it was configured in the earlier embodiments, i.e., substantially adjacent the re-coater 604.

Here, hopper 615 is distal from the re-coater 604. As noted above, hopper 615 includes a heat source for heating the powder to a designated temperature before sending it to the re-coater. Hopper 615 includes fasteners for stabilizing the structure to a frame of the system. In an embodiment, the fasteners are adjustable and the hopper may be replaced as necessary. In other embodiments, a user may use powder loading drum to resupply the hopper 615 with the powder it needs when the hopper is running low. Channel 606 carries pre-heated powder from the hopper 615 to a cavity in the re-coater 604 (omitted for simplicity). Re-coater 604 includes a leveling member that deposits the layers on the powder bed during re-coat cycles as before. The structure may also include the capability to reheat the powder bed immediately after fusion of structures during the print cycle.

In FIG. 6, while heating is performed at the hopper, re-coater 604 in this embodiment may be simplified and hopper 615, which is a larger structure, may advantageously be capable of providing more space to house an appropriately powered heat source, like heat source 618. Well thermal-insulated lines in channel 606 are recommended to prevent the thermal heat from escaping, but they are not critical to the practice of the disclosure, particularly if channel 606 is short enough in length.

In alternative embodiments, re-coater 604 may include as its heat source an embedded array of lenses that utilize the energy beam source (103) (FIG. 1) of the PBF 3-D printer 100, as opposed to expending additional power for a separate heat source. Because energy beam sources for PBF-based systems are idle during re-coat cycles, the energy beam sources 103 and their respective deflectors, if necessary, can be used for pre-heating and reheating operations during the re-coat cycle. This configuration can save energy by efficiently harnessing thermal energy during the re-coat cycles, by removing the necessity of a separate heat source and its corresponding matrix of heating elements.

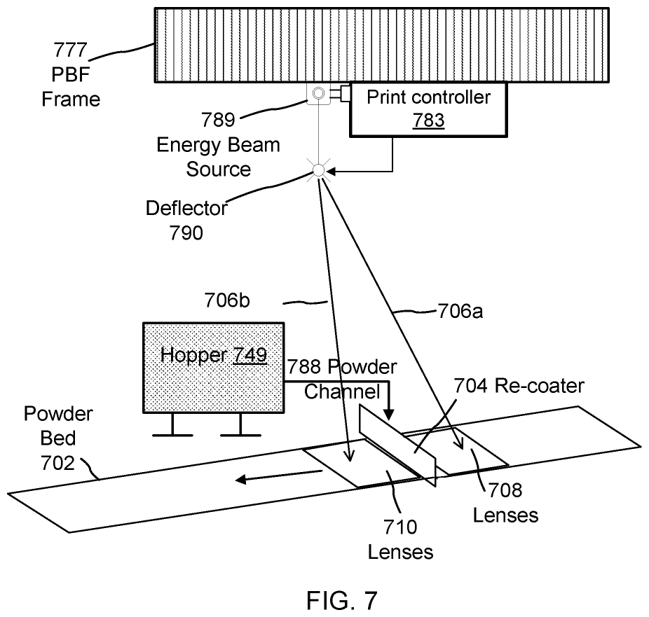

FIG. 7 is a perspective view of a re-coater 704 embedded with an array of lenses 708, 710 that utilize the energy beam source 103 of the PBF printer to heat the powder bed 702. Hopper 749 in this embodiment may be a standard hopper or another type of basin, e.g., a reservoir disposed on the left side of powder bed 702 for storing a reserve of powder. Arrow 788 is an exemplary representation of a powder channel transporting the powder from hopper 749 to re-coater 704 for use by a leveling member in depositing a layer.

In other embodiments, re-coater 704 may include a leveling member of the roller type, but in this embodiment the need for a separate heating coil in the roller can be eliminated. Alternatively, the roller may have a separate heating element to enhance the preheating capability of the PBF 3-D printer. In the embodiment shown, a re-coat cycle is underway as re-coater 704 applies a layer of powder via the leveling member. On the front side of re-coater 704 is a first lens 710 (or a plurality or array thereof), and on the back side of the re-coater is a second lens 708 (or similarly a plurality or array of lenses). The lenses are specifically designed to receive energy beams 706a-b and to focus the received light onto regions of the powder beneath them to produce heat.

In the upper part of the print chamber is an energy beam source 789, such as a laser, that may be coupled to a PBF frame 777. Energy beam source 789 is ordinarily in a disabled state during the re-coat cycle. For illustrative purposes, the energy beam source 789 can be a laser. In addition to its activity during the print cycle, energy beam source 789 is activated during the re-coat cycle under command of print controller 783. One or more lasers may be involved in this process, and they may be spread out. Laser 789 applies a light ray to deflector 790, which in turn is oriented by print controller 783 to selectively apply the energy beam to one or both lenses 710/708 as the re-coater 704 and hence the coupled lenses 710/708 traverses the powder bed 702. In the embodiment shown, light rays 706a-b are multiplexed via print controller 783 to heat both sides of re-coater 704, although in other embodiments multiple energy beam sources 789 and deflectors 790 may be used for this purpose. The lenses 710/708 receive the light energy and focus the beam onto the underlying powder which is being deposited by the re-coater. The result is that the powder bed 702 is heated using the energy beam source 789. The magnitude of heating is controlled by the strength of the laser and the lenses and the duration of receipt of a laser beam as set by print controller 783. Too high a strength is unwanted, as the lens may become dangerously close to reaching the threshold of fusing the powder. Too low a strength is equally undesirable, as the powder will not become warm enough to reduce the thermal gradients by an adequate amount.

Although frame 777 is shown as being coupled to print controller 783 and energy beam source 790, the structural arrangement of elements in the system may vary, and a number of such arrangements is possible.

Advantages of the lens embodiments include reduced complexity of the system, since a separate heat source is no longer needed to heat the powder layers. Also, the system can perform both pre-heat and reheat operations, since the energy beam source 789 is otherwise available for use during the re-coat cycles of 3-D printers and is conventionally only needed in PBF printers during the print cycles. In addition, the powder layers are directly heated in these embodiments, unlike the conventional warming of the print plate which invariably becomes far away from the surface of the powder bed where the thermal stress control is needed most.

In another embodiment, a PBF rotary motion system is used. PBF rotary systems differ from standard linear PBF printers in that the powder bed is circular-shaped. Also, the travel of the re-coater is circular as it moves around the rotary powder bed in a circular fashion.

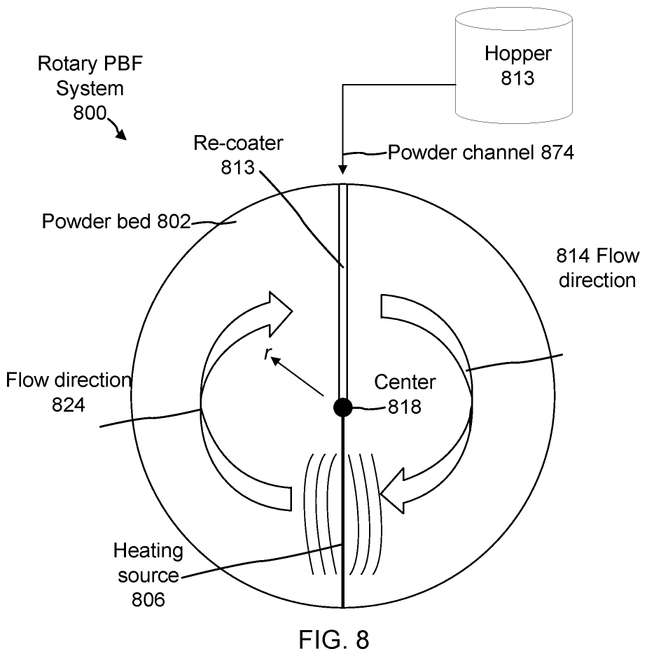

FIG. 8 is a top-view diagram of a rotary PBF system 800 having a heating source 806 coupled to the re-coater 813 in accordance with an embodiment. Similar to standard PBF systems, rotary PBF printers to date have not had a direct heating source for pre-heating and/or reheating the powder layers to minimize thermal stresses and maximize structural integrity of the build piece. When viewed from above, heating source 806 may be shown (as here) as a single strand of material. However, heating source 806 in other embodiments may include additional circuitry embedded on a side or top of the heat element 806. In an embodiment, heating source 806 is constructed as small as reasonably practicable to allow heat to flow directly onto a powder bed 802 while maintaining a comparatively simple design.

Heating source 806 begins at a center 818 of the rotary system 800 and is configured to extend out to the circumference of powder bed 802. In an embodiment, heating source 806 sweeps about the center in a clockwise fashion relative to the top view, in flow direction 814 and 824. Re-coater 813 is also disposed on powder bed 802 and originates at center 818 and moves in flow direction 814 and 824, but is arranged in this example to be 180° from heating source 806. Heating source 806 can be connected to the re-coater 813 at center 818. During a re-coat cycle, re-coater 813 applies its leveling member to the powder it receives via a powder channel 874 from a hopper 813 or reservoir-based storage tank and would encircle the system to depositing the next layer. Since FIG. 8 is a top view of the powder bed elements, hopper 813 and powder channel 874 are shown in a conceptual, simplified manner. The structural details of these elements may vary and a large number of different embodiments are possible.

Meanwhile, heating source 806 can “follow” the re-coater 813 out-of-phase by heating the circularly-deposited powder layer to a desired temperature dictated by the print controller and the capabilities of the heating source This layout of the re-coater applying a layer followed by the heating source in flow direction 814/824 can achieve a more uniform and predictable heat map.

In an embodiment, a power emitted by heating source 806 is variable across a radial direction “r” of powder bed 802. That is to say, heating source 806 may apply a constant amount of heat at the center 818, and then apply a linearly increasing amount of heat to the powder layer as a point on the heat source 806 moves farther in radial direction r towards the circumference of the circle. Conversely, in another embodiment, the application of heat by the heating source 806 may be highest in the center and may be reduced at the edge. This latter application may be more ideal in situations where the build piece is configured to be centered at the center 818 of the circular powder bed 802. In various embodiments, the radial increase or decrease in heat may be approximately linear or exponential, or it may follow another pattern.

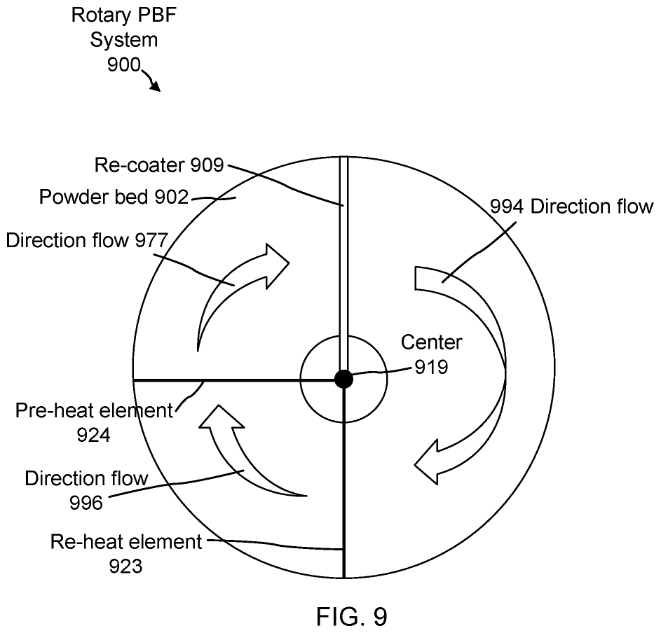

FIG. 9 is a top-view diagram of a rotary PBF system 900 having separate heat sources including a pre-heat element 924 and a re-heat element 923 for pre-heating and re-heating a powder bed 902, respectively, in accordance with an embodiment. Re-coater 909 originates at a center 919 and is configured to sweep around the circumference of the powder bed 902, as contemplated in the prior example. Also included in this embodiment is pre-heat element 924, which is configured under print controller directions to lag behind re-coater 909 and to heat the surface of the layer applied by the leveling member of the re-coater, as conceptually illustrated by direction flows 977 and 994. In this embodiment, an additional re-heat element 923 is included for heating powder bed 902 after an energy beam source associated with rotary PBF system 900 has selectively fused the layer in question. The re-heat source can be at a separate phase to avoid interference with re-coater 909 and pre-heat source 924. Direction flows 977 and 996 show the directions of re-heat source 923 and the pre-heat source 924, respectively. Advantageously, rotary PBF system 900 can include adjustable angles such that a print controller (or a user of the 3-D printer) can select the angles (whether static or variable) between pre-heat source 924, re-heat source 923 and re-coater 909 to achieve an optimal heating temperature for the build piece. The orientation of these heating elements with respect to the re-coater may be optimized using the adjustable angle feature to maximize energy input and minimize re-coat delays.

In all of these embodiments with respect to the different printer types, using reheating to heat the area again can result in stretching out the heat application over a longer period of time, resulting in lower stresses, less or no cracks, less deformation, and a generally longer lifetime of the part.

A further benefit of pre-heating and reheating the powder bed surface is that the air gap between the powder particles of the un-melted powder and the heated powder may increase the effective thermal conductivity of the un-melted powder, further reducing distortion during printing. Dimensional accuracy of the build piece can be dramatically improved by mitigating these thermal stresses using application of heat directly onto the powder bed surface.

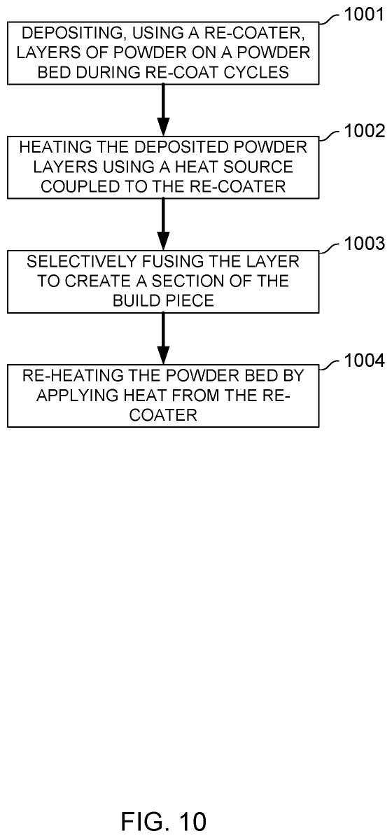

FIG. 10 is a flow chart describing an exemplary method for thermal management in accordance with an embodiment. At step 1001, the re-coater deposits layers of powder on a powder bed during respective re-coat cycles. At step 1002, the heat source heats the deposited powder layers using a heat source coupled to the re-coater, such as in the examples shown heretofore.

Next, at step 1003, the print cycle occurs for the deposited layer, and the printer's energy beam source and deflector selectively fuses the layer to create a section of the build piece. Thereupon, in some embodiments, the re-coater re-heats the powder bed by applying heat from the re-coater, as shown in step 1004.

The previous description is provided to enable any person skilled in the art to practice the various aspects described herein. Various modifications to the exemplary embodiments presented throughout this disclosure will be readily apparent to those skilled in the art, and the concepts disclosed herein may be applied in other contexts and for different purposes. Thus, the claims are not intended to be limited to the exemplary embodiments presented throughout the disclosure, but are to be accorded the full scope consistent with the language claims. All structural and functional equivalents to the elements of the exemplary embodiments described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), or analogous law in applicable jurisdictions, unless the element is expressly recited using the phrase “means for” or, in the case of a method claim, the element is recited using the phrase “step for.”

What is claimed is:

1. A re-coater for a powder bed fusion (PBF) three-dimensional (3-D) printer, the re-coater comprising:
a heat source configured to heat a powder layer, the powder layer being deposited by the re-coater on a powder bed during a re-coat cycle.

2. The re-coater of claim 1, wherein the heat source is configured to heat the powder layer during the re-coat cycle and prior to a print cycle in which an energy beam source selectively fuses the powder layer.

3. The re-coater of claim 2, wherein the heat source is further configured to heat the powder layer after the print cycle and prior to a next re-coat cycle.

4. The re-coater of claim 1, wherein the heat source is configured to heat the powder layer after a print cycle and prior to a next re-coat cycle, wherein an energy beam source selectively fuses the powder layer during the print cycle.

5. The re-coater of claim 1, wherein the heat source is further configured to heat the powder layer responsive to 3-D printer instructions.

6. The re-coater of claim 1, further comprising a leveling member configured to level the powder layer.

7. The re-coater of claim 6, wherein
the PBF 3-D printer comprises a rotary 3-D printer; and
the leveling member and heat source are configured to sweep angularly around a central location of the powder bed at an adjustable angle relative to one another.

8. The re-coater of claim 7, wherein a power emitted by the heat source is variable across a radial direction of the powder bed.

9. The-re-coater of claim 6, wherein the leveling member comprises at least a blade or a roller.

10. The re-coater of claim 9, wherein the leveling member comprises a roller and the heat source is integrated within the roller.

11. The re-coater of claim 10, wherein the heat source comprises a resistive coil.

12. The re-coater of claim 6, wherein a posterior surface of the re-coater comprises one or more apertures through which the powder exits to be leveled by the leveling member for forming the powder layer.

13. The re-coater of claim 1, wherein the heat source comprises a plurality of heating elements.

14. The re-coater of claim 13, wherein the heating elements comprise at least laser diodes, embedded laser diodes, infrared lamps, or heat lamps.

15. The re-coater of claim 14, wherein the heating elements are configured to apply heat in a raster scan of the powder layer.

16. The re-coater of claim 1, wherein the heat source comprises one or more lenses configured to direct energy from an energy beam source of the PBF 3-D printer to the powder bed.

17. The re-coater of claim 1, further comprising a second heat source, wherein the heat source is configured to heat the powder layer during the re-coat cycle and the second heat source is configured to heat the powder layer upon completion of a print cycle that follows the re-coat cycle.

18. The re-coater of claim 1, wherein the heat source comprises a generally rectangular shape and is disposed at a posterior of the re-coater facing the powder bed.

19. A powder bed fusion (PBF) three-dimensional (3-D) printer having an integrated thermal management system, the PBF printer comprising:
a re-coater configured to deposit a layer of powder onto a powder bed during a re-coat cycle;
at least one energy beam source configured to selectively fuse the powder during a print cycle to form a build piece; and
a heat source configured to heat the powder during the re-coat cycle.

20. The 3-D printer of claim 19, further comprising a hopper configured to hold the powder prior to the re-coater depositing the powder,
wherein the heat source is configured to heat the powder when the powder is in transit from the hopper to the re-coater.

21. The 3-D printer of claim 19, wherein the re-coater comprises:
a cavity to receive the heated powder.

22. The 3-D printer of claim 19, wherein the heat source extends from the re-coater laterally across and above the powder bed to cover a portion of the powder bed.

23. A re-coater for a powder bed fusion (PBF) three-dimensional (3-D) printer, comprising:
a body to traverse a surface of a powder bed during a powder re-coating cycle;
a leveling member coupled to the body to level a layer of powder on the powder bed; and
a heat source coupled to the body to heat the powder.

24. The re-coater of claim 23, wherein the body comprises a cavity for receiving the powder to form the layer.

25. The re-coater of claim 24, further comprising an opening along a base of the body to deposit the powder for leveling by the leveling member.

26. The re-coater of claim 25, wherein the body is configured to traverse the surface of the powder bed in an opposite direction after a powder fusing cycle to enable the heat source to reheat the surface.

27. The re-coater of claim 25, wherein:
the heat source comprises a first lens arranged on a first side of the leveling member and a second lens arranged on a second side of the leveling member; and
the first lens is configured to pre-heat the powder using an energy beam source of the 3-D printer when the body traverses the surface in a first direction during the re-coating cycle; and
the second lens is configured to reheat the surface using the energy beam source upon completion of a fusion cycle when the body traverses the surface in a second direction opposite the first direction.
